(19) United States
(12) Patent Application Publication
(10) Pub. No.: US 2013/0309513 A1
(43) Pub. Date: Nov. 21, 2013

(54) THERMALLY AND ELECTRICALLY HIGHLY CONDUCTIVE ALUMINIUM STRIP

(71) Applicants: Volker Denkmann, Kempen (DE); Ulrich Hampel, Grevenbroich (DE); Andreas Siemen, Juchen (DE); Kathrin Eckhard, Bonn (DE); Wilhelm Schenkel, Grevenbroich (DE); Oliver Seifferth, Koln (DE)

(72) Inventors: Volker Denkmann, Kempen (DE); Ulrich Hampel, Grevenbroich (DE); Andreas Siemen, Juchen (DE); Kathrin Eckhard, Bonn (DE); Wilhelm Schenkel, Grevenbroich (DE); Oliver Seifferth, Koln (DE)

(73) Assignee: Hydro Aluminium Rolled Products GmbH, Grevenbroich (DE)

(21) Appl. No.: 13/949,911

(22) Filed: Jul. 24, 2013

Related U.S. Application Data
(63) Continuation of application No. PCT/EP2012/051232, filed on Jan. 26, 2012.

(30) Foreign Application Priority Data
Jan. 28, 2011 (DE) 102011000395.9

(51) Int. Cl. F28F 21/02; H01B 1/02; H01B 13/32

(52) U.S. Cl. CPC F28F 21/02; H01B 13/321; H01B 1/023
USPC 428/472.2; 165/185; 427/122; 427/180; 174/126.2

(57) ABSTRACT

The invention relates to a strip or foil (1) made from aluminium or an aluminium alloy that has an external oxide layer. The object of providing a strip or foil made from aluminium or an aluminium alloy in which the thermal and/or electrical conductivity remains consistently high regardless of the formation of an aluminium oxide layer is solved by arranging thermally and/or electrically highly conductive functional particles on one or both sides of the strip or foil, which functional particles at least partly penetrate the oxide layer of on the strip or foil.

### CROSS-REFERENCE TO RELATED PATENT APPLICATIONS

This patent application is a continuation of PCT/EP2012/051232, filed Jan. 26, 2012, which claims priority to German Application No. 102011000395.9, filed Jan. 28, 2011, the entire teachings and disclosure of which are incorporated herein by reference thereto.

### FIELD OF THE INVENTION

The invention relates to a strip or foil consisting of aluminium or an aluminium alloy that has an outer oxide layer. The invention further relates to a method for producing a strip or foil according to the invention and use thereof.

### BACKGROUND OF THE INVENTION

Aluminium or aluminium alloys are used widely for electrically and/or thermally conductive components. Examples of such include solar absorbers, which are used in the field of solar thermal energy, that is to say the recovery of heat from the sun's rays. Battery electrodes and printed circuit boards certainly, but also current conducting cables and their plugs and contacts are often made from aluminium, because aluminium or aluminium alloys have particularly low electrical resistances. However, if an aluminium or aluminium alloy strip is exposed to air, a layer of aluminium oxide, usually from 2 to 4 nm thick, forms quite quickly. On the one hand, this aluminium oxide layer is desirable to protect the aluminium or aluminium alloy from further corrosion. On the other hand, the heat and electricity conducting properties of said aluminium oxide layer are significantly poorer, resulting in problems with the transfer of heat or electricity particularly at contact points between two different components. To solve these problems in electrical contacts for example, attempts have been made to provide strips or foils of aluminium alloys with highly conductive coatings. However, this has not led to the desired result, because the aluminium oxide layer between the highly conductive coating and the core of the aluminium strip prevents said aluminium strip core from contributing to the conductivity thereof to its full extent. Therefore, electrical conductivity, and thermal conductivity as well, is in need of improvement.

### SUMMARY OF THE INVENTION

Proceeding from the above situation, the object underlying the present invention is to provide a strip or foil made from aluminium or an aluminium alloy in which the thermal and/or electrical conductivity remains consistently high regardless of the formation of an aluminium oxide layer. The invention further suggests a method for producing a strip or foil according to the invention and advantageous uses of the inventive strip and foil.

According to a first teaching of the present invention, the object defined above is solved by arranging functional particles having high thermal and/or electrical conductivity on one or both sides of the strip or foil, which particles at least partly penetrate the oxide layer of the strip or foil.

The functional particles having high thermal and/or electrical conductivity arranged on the surface of the strip or foil according to the invention enable the strip or foil to retain its consistently high heat and/or electricity conducting properties irrespective of the formation of the aluminium oxide on the surface thereof by virtue of the fact that they pass through the aluminium oxide layer. The functional particles having high thermal and/or electrical conductivity conduct the heat or electric current straight through the oxide layer on the aluminium or aluminium alloy strip or foil and into the core of the aluminium or aluminium strip or foil. The aluminium oxide layer, which is formed by air on the strip or film made from aluminium or an aluminium alloy, no longer degrades the thermal and/or electrical conductivity of the strip or foil according to the invention.

According to a first variant, nanotubes, carbon nanotubes and/or carbon fibres having high electrical and/or thermal conductivity are provided as the function particles. Said nanoparticles are highly conductive and are able to penetrate the aluminium oxide layer, so that they can conduct the electric current for example from the surface and into the interior of the strip or foil consisting of aluminium alloy or aluminium. Thus, the entire strip or foil is involved in the flow of current and/or heat. Carbon nanotubes and carbon fibres are also extremely thermally stable, so that the usual process steps for processing the strips of foils according to the invention do not pose any difficulties.

Components having particularly good electrical and/or thermal conductivity properties may be provided by producing a panel from a strip according to the invention. The panel is typically turned into a specific component by forming steps or by additional process steps and has excellent electrical and/or thermal conductivity properties regardless of the formation of an aluminium oxide layer on the surface of the aluminium or aluminium alloy.

According to a second teaching of the present invention, the object state above is achieved with a method for producing a strip or foil, by embedding the functional particles having high thermal and/or electrical conductivity in the surface of the strip or foil by mechanical means. For the purposes of the invention, the phrase “embedding by mechanical means” is understood to mean that the functional particles having high thermal and/or electrical conductivity are pressed into the surface of the strip or foil according to the invention by applying a mechanical force. This has the advantage of rendering the aluminium oxide layer on the surface of the strip or foil easily penetrable so that contact is made with the underlying core of the strip or foil according to the invention. Moreover, the mechanical application of particles to the surface of a workpiece is particularly simple and environmentally friendly.

According to a first variant of the method for producing a strip or foil according to the invention, a bonding agent or primer is spread over the surface of the strip or foil before the mechanical application of the functional particles. The primer or bonding agent ensure that the nanoscale functional particles may be arranged on the aluminium strip or foil in simple manner, and cannot be detached from the strip or foil, by thermal energy or a flow of air for example, because of their size. In addition, the bonding agent or primer affords the capability of preparing the surface of the aluminium strip for the application of the functional particles.

The functional particles may be introduced mechanically into the surface of the strip or foil successfully and particularly simply by rolling the functional particles into the surface of the strip or foil. This means particularly that conventional process steps can be used to manufacture strips or foils from aluminium or aluminium alloy, and the method thus involves only minor investment costs. At the same time, any of the rolling steps already implemented in the production of the strip or foil according to the invention may be used to arrange the functional particles on the surface of the strip in such a manner that they ate least partly penetrate the oxide layer of the strip or foil. In principle, this means that any of the intermediate steps is suitable for introducing the functional particles into the surface.

The step of rolling the functional particles into the surface is preferably performed by hot rolling, cold rolling and/or skin-pass rolling. With skin-pass rolling, there is usually little or no change in the thickness of the strip or foil, but a specific surface texture is created in the strip or foil. This process can be used to introduce the functional particles just as well as the cold rolling or hot rolling of the strip or foil normally used in production. At the same time, the functional particles may be rolled in successfully regardless of whether the strip has been made from a rolled ingot or has been cast and rolled directly.

According to a further variation of the method, as surface structure is created in the strip or foil preferably before the functional particles are rolled in, and the functional particles are distributed over and subsequently rolled into the textured surface. The textured surface may be used for example to create specific distribution patterns of the functional particles or to improve the adhesion of the particles to the surface of the strip or foil, for example in that the nanoscale particles collect in the texture recesses.

The functional particles may be introduced into the inventive strip or foil particularly gently if the functional particles are introduced in rolled in in 1 to 10 successive rolling steps. If thicknesses reduced very significantly, difficulties may be caused by the functional particles being present not only in the surface layer. Through the application of multiple rolling steps to introduce the functional particles, the amount by which the strip is made thinner may be reduced for each rolling step, so that the functional particles are only embedded in the surface areas. Of course, as the number of rolling steps increase, so too does the cost of producing the inventive strip or foil.

According to a further variation of the method according to the invention, the functional particles are preferably deposited on the surface of the strip or foil in the form of a dispersion, a suspension or a powder before they are mechanically embedded in the surface. If the functional particles are deposited in the form of a dispersion or suspension, inadvertent removal of the functional particles from the surface of the strip before rolling may be prevented in simple manner, since the functional particles are present on the strip or foil together with the liquid dispersion or suspension. It is also possible to ensure in simple manner that the functional particles are distributed particularly evenly on the surface of the strip or foil. If the functional particles are applied to the strip or foil in powder form, the rolling oil present on the surface of the strip or foil for example may be used to assist adhesion of the functional particles to the surface of the strip or foil. Rolling oil is a medium that is constantly present during the mechanical processing of strips or foils, the behaviour of which both before and after rolling is very well known. Moreover, no additional substances are required in order to place the functional particles on the strip or foil.

Finally, the object indicated above is achieved by use of a strip or foil according to the invention to manufacture conductors of electrical current and/or components with excellent heat conducting properties.

A preferred use of the strip or foil according to the invention is the manufacture of components with excellent heat conducting properties in the form of solar absorbers. In principle, however, other heat exchangers and other components that exploit the good thermal conductivity of aluminium may be produced from a strip or foil according to the invention. Electrical contacts, battery electrodes, electronic printed circuit boards are further products that may be created using the strip or foil according to the invention, and have clear advantages in terms of electrical conductivity over the aluminium or aluminium alloy parts of the products mentioned.

### BRIEF DESCRIPTION OF THE DRAWINGS

In the following, the invention will be described in greater detail with reference to embodiments thereof and in conjunction with the drawing. In the drawing:

FIG. 1 is a cross-sectional view of a first embodiment of a strip according to the invention,

FIG. 2 is an enlarged view of section A of FIG. 1,

FIG. 3 is a perspective view of a second embodiment with a textured surface, and

FIG. 4 is a diagrammatic view of a device for carrying out the method according to the invention.

### DETAILED DESCRIPTION OF THE INVENTION

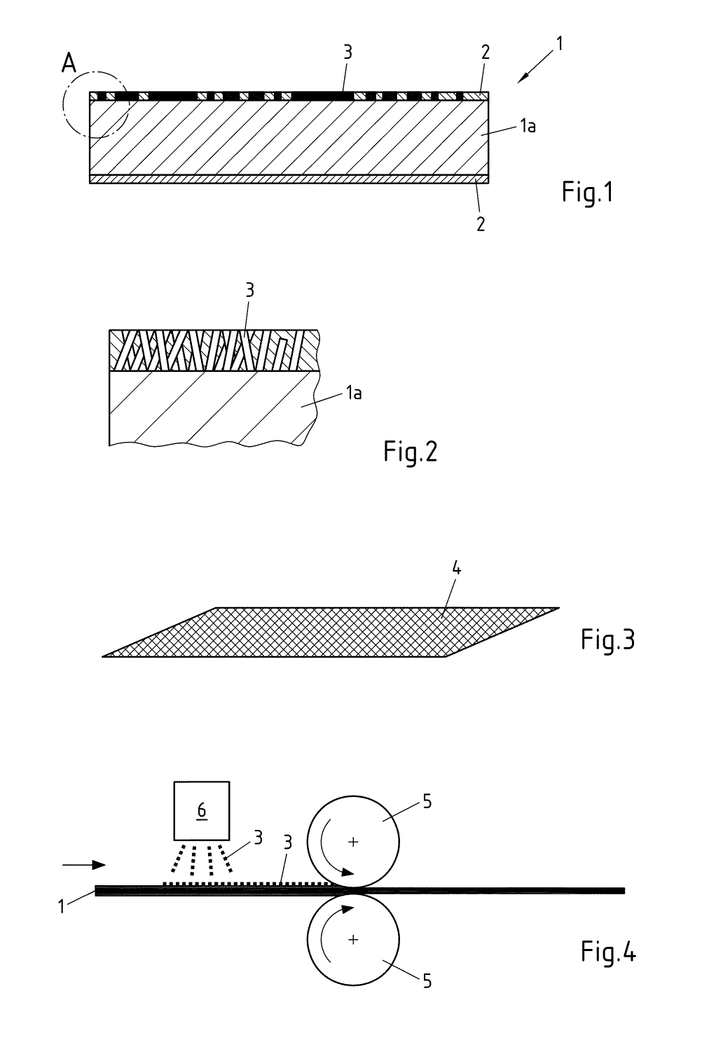

FIG. 1 is a schematic cross-sectional view of an embodiment of strip 1 having an oxide layer 2 on both sides thereof. Thermally and/or electrically highly conductive functional particles 3 are incorporated in upper oxide layer 2 and partially penetrate oxide layer 2. The embodiment of a strip 1 shown in FIG. 1 includes functional particles introduced on one side thereof. Of course, it is conceivable to provide highly conductive functional particles 3 in both oxide layers on strip 1. The highly conductive functional particles 3 are in contact with the core material 1a of strip 1, so that in the case of conducting current for example functional particles 3 convey the electric current into the core region of strip 1a without obstruction, the core region being highly conductive. Aluminium oxide layer 2 then no longer has a significant effect on the electrical and/or thermal conductivity of the strip 1 or foil according to the invention. Strip 1 according the invention may have a thickness for example from 15 mm to 0.1 mm. On the other hand, foils according to the invention have thicknesses from 100 μm to 10 μm.

As may be seen in FIG. 2, which shows an enlargement of section A, “carbon nanotubes” (CNT) have been used as the highly thermally and/or electrically conductive functional particles. It has been found that particularly carbon nanotubes or carbon fibres can be incorporated in the strip or foil such that they at least partly penetrate the constantly present oxide layer 1 and also constitute a permanent connection with core 1a of the strip or foil. With the strip or foil according to the invention, therefore, strips or foils are provided having significantly improved properties in terms of electrical and/or thermal conductivity.

As explained earlier, the highly thermally and/or electrically conductive functional particles may also be incorporated in the strip or film during skin-pass rolling. The result is a strip having a surface texture in which the thermally and/or electrically conductive functional particles are arranged as shown diagrammatically in FIG. 3. Consequently, surface structure 4 is thermally and/or electrically highly conductive.

FIG. 4 is a diagrammatic illustration of a method for producing the strip or foil according to the invention. The figure shows schematic representations of work rolls 5, which reduce the thickness of strip 1. Thermally and/or electrically highly conductive functional particles 3 are deposited on the strip, that is to say distributed evenly on the surface of the strip for example in the form of a suspension or dispersion for example via a device 6. However, functional particles 3 may also be applied in powder form. Once the functional particles have been distributed on the strip, they are embedded in the surface layer by means of work rolls 5 in such a manner that they at least partly penetrate the oxide layer. For the sake of simplicity, the oxide layer is not shown in FIG. 4. Work rolls 5 may be for example the work rolls of a hot rolling, a cold rolling or a skin-passing rolling installation.

1. A strip or foil comprising an aluminium or an aluminium alloy that has an external oxide layer, wherein thermally and/or electrically highly conductive functional particles are arranged on one or both sides of the strip or foil, which functional particles penetrate the oxide layer of the strip or foil, and wherein electrically and/or thermally highly conductive nanotubes, carbon nanotubes (CNT) and/or carbon fibres are embedded mechanically in the oxide layer on the surface of the strip or foil are provided as the functional particles.

2. A panel produced from a strip according to claim 1.

3. A method for producing a strip or foil according to claim 1, wherein electrically and/or thermally highly conductive nanotubes, carbon nanotubes (CNT) and/or carbon fibres are provided as functional particles and the functional particles are incorporated mechanically in the oxide layer on the surface of the strip or foil.

4. The method according to claim 3, further comprising a step wherein a bonding agent or primer is spread on the strip or foil before the electrically and/or thermally highly conductive functional particles are mechanically incorporated in the surface of the strip or foil.

5. The method according to claim 3, further comprising a step wherein the thermally and/or electrically highly conductive functional particles are rolled into the surface of the strip or foil.

6. The method according to claim 5, wherein the thermally and/or electrically highly conductive functional particles are embedded by hot rolling, cold rolling and/or skin-pass rolling.

7. The method according to claim 5, wherein a surface structure is created in the strip or foil before the thermally and/or electrically highly conductive functional particles are rolled in, and the thermally and/or electrically highly conductive functional particles are distributed on the surface structure and then rolled in.

8. The method according to claim 5, wherein the thermally and/or electrically highly conductive functional particles are rolled into the surface of the strip or foil in from one to ten rolling steps.

9. The method according to claim 3, wherein the thermally and/or electrically highly conductive functional particles are deposited on the surface of the strip or foil in dispersion, suspension or powder form before the mechanical incorporation thereof in the surface.

10. Use of a strip or foil according to claim 1 in order to produce elements for conducting electrical current and/or highly thermally conductive components.

11. The use according to claim 10, wherein the strip or foil is used in the manufacture of electrical contacts, battery electrodes, electronic printed circuit boards, solar absorbers, heat exchangers.
